(19) United States
(12) Patent Application Publication
(10) Pub. No.: US 2018/0307394 A1
(43) Pub. Date: Oct. 25, 2018

(54) TOUCHSCREEN CALCULATOR TRI TECH

(71) Applicant: Najeeb Haymour, Newmarket (CA)

(72) Inventor: Najeeb Haymour, Newmarket (CA)

(21) Appl. No.: 15/491,846

(22) Filed: Apr. 19, 2017

(51) Int. Cl. G06F 3/0488; G06F 3/0481

(52) U.S. Cl. CPC G06F 3/0488; G06F 15/0225; G06F 3/04817; G06F 3/0481

(57) ABSTRACT

A touch screen calculator is provided that may be configured to provide advanced and user-friendly calculations. The present invention may also provide for a user-friendly and sleek design. Additionally, the present invention's computer-executable instructions may provide for a basic, a graphing, or a financial configuration, among other embodiments.

### CROSS-REFERENCE TO RELATED APPLICATION

This application does not claim priority to any prior U.S. Provisional application.

### TECHNICAL FIELD

The present invention relates generally to the field of calculators and more specifically relates to a touchscreen calculator having proprietary computer-implemented technology.

### BACKGROUND

The ability to performing accurate mathematical calculations is a requirement in today's society. Whether it is counting change, calculating a payment, or even planning a schedule, many daily tasks require at least some mathematical computation. Additionally, many students are required to not only solve “daily math” problems, but advanced calculations. And of course, some professions require mathematics as part of the professional's daily routine. In these and other circumstances, calculators are often very useful.

However, many calculators are either cumbersome or outdated. As such, today's average citizens, students, and mathematical professionals need a calculator with the right size, the right touchscreen features, and the right series of interfaces to truly meet their needs.

Various attempts to meet these needs have been made. One such attempt can be seen with respect to U.S. Patent Application Publication No. 2010/0156808 A1, incorporated by reference in its entirety herein, which generally discloses a touchscreen interface. While this disclosure does teach a touchscreen interface capable of use with a calculating function, the design of the device does not provide for the needs outlined above, and it fails to provide for discrete models aimed at different computational requirements.

Another attempt can be seen with respect to U.S. Pat. No. 6,928,899, incorporated by reference in its entirety herein, which generally discloses a graphing calculator with a touchscreen interface. While this disclosure does generally provide for a graphing calculator with a touchscreen interface, it fails to provide for a touchscreen calculator having a desirable design or that provides for embodiments wherein the disclosure is configured for primarily basic or financial operations.

Yet another attempt can be seen with respect to U.S. Pat. No. 7,730,401, incorporated by reference in its entirety herein, which generally discloses another touchscreen interface device. While this disclosure does provide for an enhanced mobile interface design, its calculator capabilities are limited.

As can be seen, various attempts have been made to solve the problems which may be found in the related art but have thus far been unsuccessful. A need exists for a new touchscreen calculator to avoid the above-mentioned problems.

### SUMMARY OF THE INVENTION

It is to be understood that in the present disclosure, all embodiments are provided as illustrative and non-limiting representatives of many possible embodiments. In addition, the terms “is,” “can,” “will,” and the like are herein used as synonyms for and interchangeable with terms such as “may,” “may provide for,” and “it is contemplated that the present invention may” and so forth.

The present invention relates to a touchscreen calculator that overcomes the deficiencies of the prior art. It is contemplated that the present invention may provide users with an advanced touchscreen interface that enables easy mathematical computing.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

In view of the foregoing disadvantages inherent in the known art, the present invention provides a novel touchscreen calculator. The general purpose of the present invention, which will be described subsequently in greater detail, is to enable users to calculate numerical terms and equations on a newly and advanced hardware and software. The features of the invention which are believed to be novel are particularly pointed out and distinctly claimed in the concluding portion of the specification. These and other features, aspects, and advantages of the present invention will become better understood with reference to the following drawings and detailed description.

In one embodiment, the present invention may provide for a software-operated calculator with improvements over the older model calculators. The present invention will come in different designs and models depending on what the user's computational needs. In some embodiments, the present invention's hardware will have a power button and a charging port to recharge the battery and an HDMI port.

In one embodiment, the present invention may enable the user to solve basic mathematical equations and formulas. In this embodiment, the user will begin by starting the device by holding the power button. Then, the present invention may display a logo to indicate its authenticity and reliability to the user, and to indicate that the system is working properly. Next, the present invention may provide the user with an option for a tutorial, wherein the user can either read the tips or get started right away.

The present invention may provide for one or more advanced or traditional elements known in the art, but the combination and method of which it is contemplated is novel. By way of illustration and not limitation, in some embodiments, the present invention's operating system (“OS”) may display the date, time, weather on the present invention's screen. The OS will then pop up and the user will be able to make the calculations necessary. The user will have the option of dragging their finger from the top of the screen and drag down a menu or functions bar, that may be entitled “Tech Bar,” to access different options. The OS will give the user the option to customize the color of the keys and display. Additionally, in some embodiments, the user may be able to change or customize which button(s) or key(s) they would like to have on display by holding down and dragging the unwanted key into the bin or by dragging down the Tech bar and simply clicking the “+” key to add more keys to the display. This embodiment may include a Bluetooth and an HDMI port to transfer the calculator's contents to a bigger screen (such as a smart television or a direct connection to the television). The OS will give the user the option to swipe left on the display and it will take the user to the home page where the date, time and the weather will be displayed. The OS may also give the user the option to use voice activation to make their calculations by saying, by way of illustration and not limitation, using “Hey Techy” at the beginning of their question. For example, “Hey Techy, what's 6+5−2?” The OS will give the user the option to change or customize the colors of the keys or buttons that are on the display. And, in order to turn the unit off, a user may simply press and hold the power button.

Additionally, in some embodiments the numbers or keys that may be included in this model are: −1,2,3,4,5,6,7,8,9,0—+ (plus), − (minus), = (equals), % (percentage), Divide (laptop doesn't have this key), C (clear), . (decibel), Square Root (laptop doesn't have this key). Additionally, in some embodiments, the present invention may provide for an option to make the screen brighter or dimmer, an option to activate/connect to another bluetooth device, an option to turn on the voice activation, an option to add more keys to the display, and an option to view, edit and go back to previous (saved) calculations.

In other embodiments, the present invention may enable the user will be able to solve more advanced calculations like graphing equation and triganomic equations. In this embodiment the user will begin with starting the present invention by holding the power button, and the present invention will then display a logo on the screen. Once a logo such as “Tri Tech” has been introduced to the user, a feature such as The Tech Page will pop up and will give the user the option on which function they would like to use. Once the user has selected the function, an option for a tutorial and tips will be given to the user. The OS will be very similar to the first-described embodiment(s), and yet there will be a few more options, as in some embodiments the present invention provides for more advanced calculator functionalities. As in other embodiments, in some embodiments, the OS will have cellular data in order to display the date, time, weather and voice activation. The OS will then pop up and the user will be able to make the calculations necessary. The user will have the option of dragging their finger from the top of the screen and drag down the “Tech Bar” to access different options. Also they will be able to change or customize which button(s) or key(s) they would like to have on display by holding down and dragging the unwanted key into the bin or by dragging down the Tech bar and simply clicking the “+” key to add more keys to the display. In some embodiments, the present invention may also include a bluetooth and an HDMI port to transfer the contents of the calculator to a bigger screen (smart television or a direct connection to the television). The OS will give the user the option to swipe left on the display and it will take the user to the home page where the date, time and the weather will be displayed. The OS will also give the user the option to use voice activation to make their calculations by saying “Hey Techy” at the beginning of their question. For example, “Hey Techy, whats 6+5−2.” Additionally, some embodiments may provide for many more input keys/buttons as these embodiments are more advanced calculators. For example, different embodiments may provide that the OS will give the users the option on the “Tech Page” which software they would like to use, or the OS will have multiple pages as the user will have a page for inputing the equation needed and the second page will be mainly for graphing the equation. In such an embodiment, the second page will give the user the option to edit/change the equation in case of a typo or a key that is not needed. The OS may also give the user the option as to what subject they will want to use this for. In some embodiments, the present invention may be able to perform mathematical terms such as: Algebra, Trigonometry, Geometry, Pre-calculus, Calculus/AP Calculus, Statistics, AP Statistics, College Math, Electrical Engineering, Mechanical Engineering, Differential Equations, Linear Algebra, Life Science, Earth Science, or Physical Science.

In other embodiments, the present invention may enable a user to solve financial equations and formulas and will be used for financial purposes. In some embodiments, the user will begin with starting the device by holding the power button, the unit will then display a logo on the screen. Once a logo such as “Tri Tech” has been introduced to the user, an option for a tutorial will be brought up for the user, they can either read the tips or get started right away. The OS will have a display the date, time, weather. The OS will then pop up and the user will be able to make the calculations necessary. The user will have the option of dragging their finger from the top of the screen and drag down the “Tech Bar” to access different options. Also they will be able to change or customize which buttons or keys they would like to have on display by holding down and dragging the unwanted key into the bin or by dragging down the Tech bar and simply clicking the “+” key to add more keys to the display. In some embodiments, the present invention may include a bluetooth and an HDMI port to transfer the calculator's contents to a bigger screen (such as a smart television or a direct connection to the television). The OS will give the user the option to swipe left on the display and it will take you to the home page where the date, time and the weather will be displayed. The OS will also give the user the option to use voice activation to make their calculations by saying “Hey Techy” at the beginning of their question. For example, “Hey Techy, what's 6+5−2?” The OS will give the user the option change or customize the colors of the keys or buttons that are on the display. In order to turn the present invention off, a user may simply press and hold the power button.

In some embodiments, the Tech Bar may include an option to make the screen brighter or dimmer, an option to activate/connect to another bluetooth device, an option to turn on the voice activation, an option to add more keys to the display, an option to view, edit and go back to previous (saved) calculations.

In brief, in some embodiments, the present invention may comprise a touch screen calculator where users will be able to use it as a substitute for their existing calculators. The present invention's calculator function will allow users to calculate numerical terms/equations on a newly and advanced hardware/software. The present invention's calculator will have an HDMI port to allow users to take their experience onto a bigger screen. The present invetion's calculator will have a charging port at the bottom of the unit and a power ON/OFF at the top. The present invention's calculator will allow users to use voice recognition to calculate mathematical terms. Additionally, the present invention will have a very simple user interface. The user will turn it on and the Tri Tech logo will pop up. The user will be given the option of what style of calculation they would like to use (basic, advanced, graphing, financial, etc.) Once the user has designed on which calculation form they would like to use, they will have the full option of returning to a more basic or advanced type.

Another embodiment of the present invention is a touchscreen interface system and method, along with computer-readable instructions embedded on a non-transient medium sufficient to cause a computer device, processor, or other such element to execute the method, the system, or the system and method, depending on embodiments. The present invention may also provide for a software product embedded in one or more non-transient medium(s) capable of causing a computer to execute the disclosure as generally provided herein.

The unique features of the present invention may provide the following benefits for one or more consumers: it may change the way calculators are built or used, may re-invent the calculator industry so that users will have the experience using them in a more technological/advanced way, and may re-model the way users look at and use our calculators. It may also look more professional in the eyes of the user, presenting a very simple User Interface that suits the user's needs. The present invention may also provide for more than one interchanging or commercially available embodiments depending on what the user is looking for, such as the right size. Depending on what the profession of the user is, they may need a bigger unit for their desk. From there they will be able to obtain different accessories as in angled stands and cases for the present invention.

### BRIEF DESCRIPTION OF THE DRAWINGS

These and other features, aspects and advantages of the present invention will become better understood with regard to the following description, appended claims, and accompanying figures where:

FIG. 1 shows a perspective view of a touchscreen calculator in accordance with one embodiment of the invention.

FIG. 2 shows a planar view of a touchscreen calculator in accordance with one embodiment of the invention.

FIG. 3 shows a perspective view of a touchscreen calculator in accordance with one embodiment of the invention.

FIG. 4 shows a perspective view of a touchscreen calculator in accordance with one embodiment of the invention.

### DETAILED DESCRIPTION

The present invention overcomes the limitations of the prior art by providing a new and more effective touchscreen calculator.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well known features, elements or techniques may not be shown in detail in order not to obscure the embodiments.

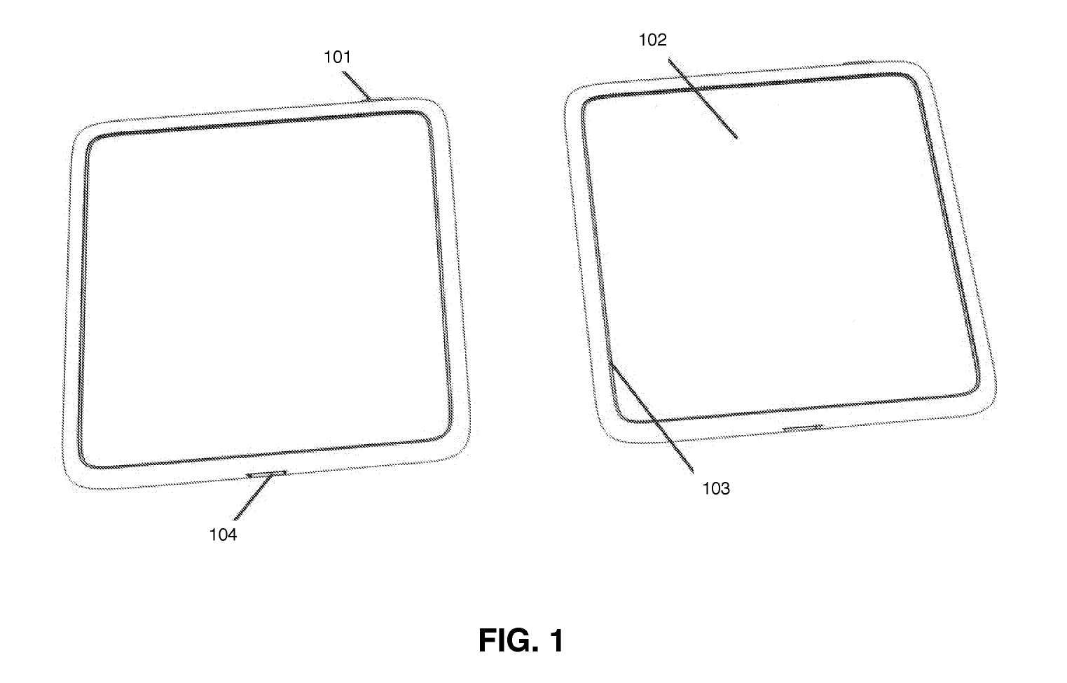

Turning attention to FIG. 1, a perspective view of a touchscreen calculator in accordance with one embodiment of the invention can be seen. In the embodiment depicted, the viewer may perceive power/lock button 101, touch screen 102, rubber lining 103, and charging port 104.

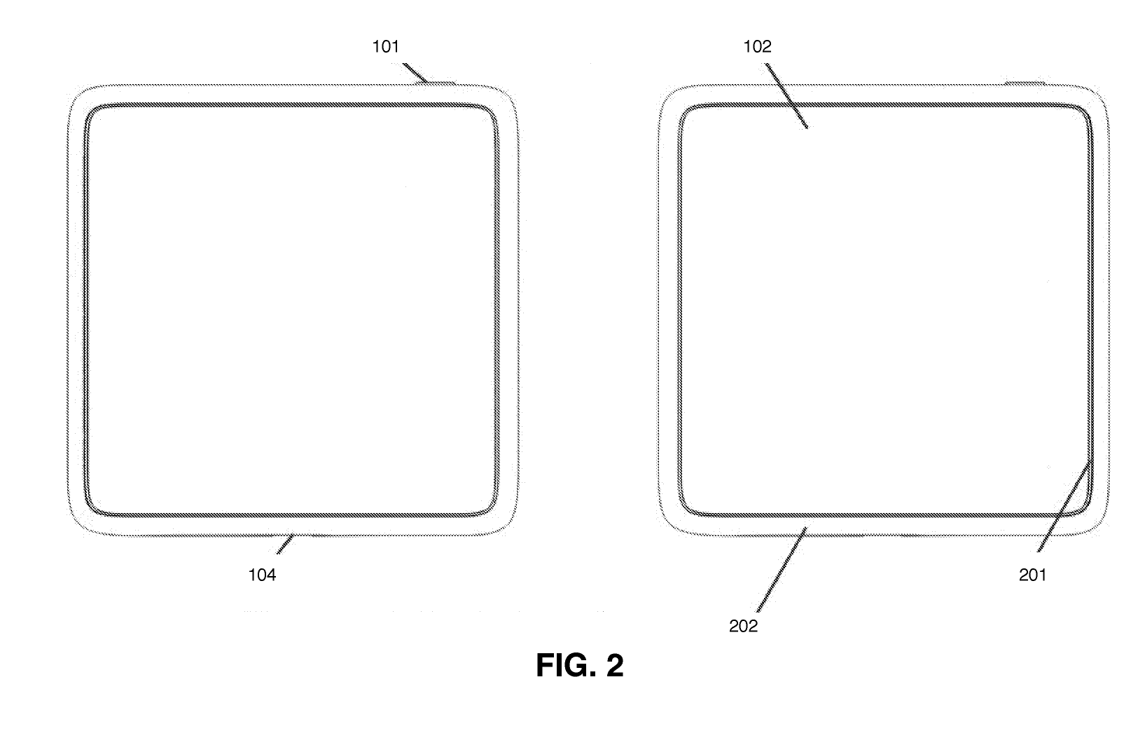

With respect to FIG. 2, a planar view of a touchscreen calculator in accordance with one embodiment of the invention can be seen. In the embodiment depicted, the viewer may perceive rubber lip 201 and rubber extension 202, as well as power/lock button 101, touch screen 102, and charging port 104. With respect to rubber extension 202, it is contemplated that the rubber may extend out to prevent touch screen 102 and the device's back from scratching.

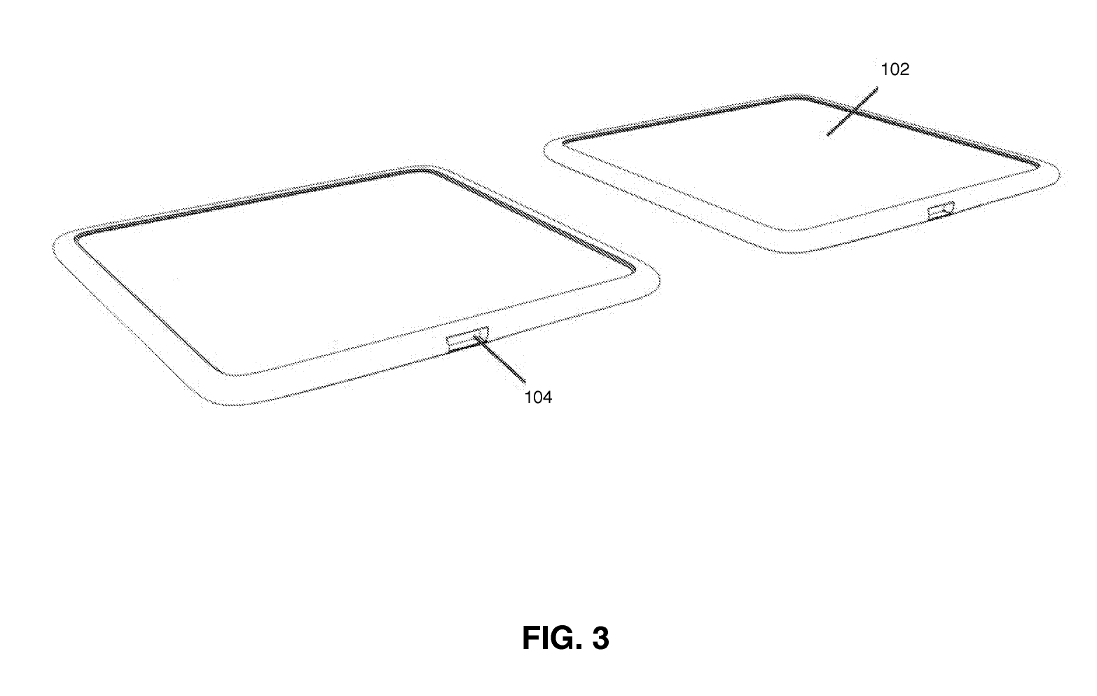

FIG. 3 shows a perspective view of a touchscreen calculator in accordance with one embodiment of the invention. In the embodiment depicted, a user may perceive touch screen 102 and charging port 104.

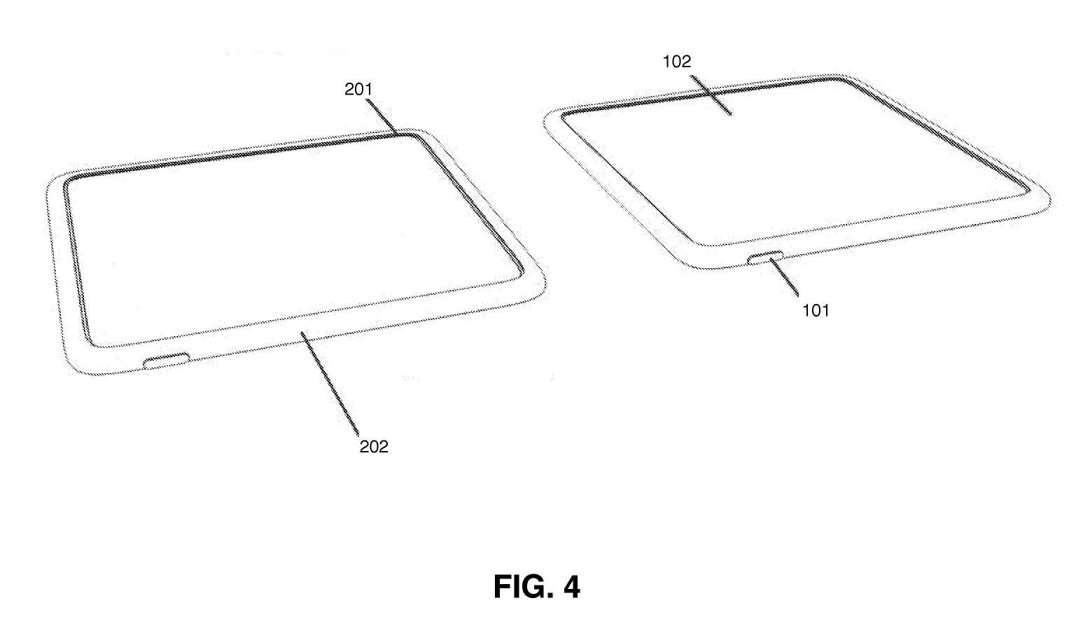

Turning attention to FIG. 4, a perspective view of a touchscreen calculator in accordance with one embodiment of the invention can be seen. In the embodiment depicted, the viewer may perceive power/lock button 101, touch screen 102, rubber lip 201 and rubber extension 202.

### CONCLUSIONS, RAMIFICATIONS, AND SCOPE

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While the touchscreen calculator generally described herein has been disclosed in connection with a number of embodiments shown and described in detail, various modifications should be readily apparent to those of skill in the art.

What is claimed is:

1. A calculator, comprising:
a center member having an interior portion, a front side, a back side, and a perimeter edge;
a port configured to pass through the perimeter edge into the interior portion;
a touchscreen display fixedly attached to the front side;
a processor fixedly connected to the inner portion, the processor being in communication with the display;
a port configured to pass through the perimeter edge into the interior portion, wherein the port is in communication with the processor; and
a button configured to pass through the perimeter edge into the interior portion.

2. The calculator of claim 1, wherein an elastomeric member is fixedly attached to the perimeter edge.

3. The calculator of claim 1, wherein an elastomeric lip is fixedly attached to the perimeter edge.

4. The calculator of claim 1, wherein the center member is square.

5. The calculator of claim 1, wherein the button is a power/lock button.

6. The calculator of claim 1, wherein the port is a charging port.

7. A non-transitory computer-readable medium having stored thereon instructions for use by a computer system, which cause the computer system to:
receive, from a user, a touch-activated command;
process, by the system, the touch-activated command; and
display, by the system, the touch activated command on a touchscreen.

8. The computer-readable medium of claim 7, wherein the touch-activated command is a basic equation.

9. The computer-readable medium of claim 7, wherein the touch-activated command is a graphing equation.

10. The computer-readable medium of claim 7, wherein the touch-activated command is a financial equation.
